(19) United States
(12) Patent Application Publication
(10) Pub. No.: US 2015/0218372 A1
(43) Pub. Date: Aug. 6, 2015

(54) ONE-COMPONENT, MOISTURE-CURING COMPOSITION

(71) Applicant: Bayer MaterialScience LLC, Pittsburgh, PA (US)

(72) Inventors: DERICK HENDERSON, Crafton, PA (US); Jay Johnston, Clinton, PA (US)

(73) Assignee: Bayer MaterialScience LLC, Pittsburgh, PA (US)

(21) Appl. No.: 14/173,193

(22) Filed: Feb. 5, 2014

(51) Int. Cl. C08L 75/02; C08G 18/38

(52) U.S. Cl. CPC C08L 75/02; C08G 18/3819

(57) ABSTRACT

A one-component composition comprising:
1) a ketimine which is the reaction product of:
   a) a dimer diamine; and
   b) a ketone; and
2) a blocked isocyanate.

### BACKGROUND OF THE INVENTION

The present invention relates to one-component, moisture-curing compositions.

Polyurethane polymers and prepolymers have long been used in coating, adhesive and sealant compositions. Blocked isocyanate prepolymers have recently been used, especially as a flexibilizer for epoxies in sealant systems. Such prepolymers are disclosed in U.S. Pat. No. 6,103,849.

It is known to form polyurea elastomers from the reaction between blocked isocyanate prepolymers and amines. Depending on the particular amines selected and the reaction conditions, such reactions can occur at an unmanageably fast pace. It has been suggested in U.S. Pat. No. 5,104,930 that blocked amines may be used to slow down such reactions. However, the inventors hereto have found the use of blocked amines lead to elastomers which do not fully cure, even after twenty-one days.

It was an object of the present invention to develop a one-component, moisture curing composition which utilizes blocked amines, but cures in a reasonable amount of time.

This object may be obtained with the compositions according to the invention, which are described below in greater detail.

### SUMMARY OF THE INVENTION

The present invention relates to a one-component composition comprising:
1) a ketimine which is the reaction product of:
   a) a dimer diamine; and
   b) a ketone; and
2) a blocked polyisocyanate.

### BRIEF DESCRIPTION OF SEVERAL DRAWINGS

FIG. 1 is a graphical illustration of the Tensile results for Examples 2-5.

FIG. 2 is a graphical illustration of the Elongation results for Examples 2-5.

FIG. 3 is a graphical illustration of the Tear results for Examples 2-5.

FIG. 4 is a graphical illustration of the Hardness results for Examples 2-5.

FIG. 5 is a graphical illustration of the Tensile results for Examples 6-11.

FIG. 6 is a graphical illustration of the Elongation results for Examples 6-11.

FIG. 7 is a graphical illustration of the Tear results for Examples 6-11.

FIG. 8 is a graphical illustration of the Hardness results for Examples 6-11.

### DETAILED DESCRIPTION OF THE INVENTION

Various embodiments are described and illustrated in this specification to provide an overall understanding of the structure, function, operation, manufacture, and use of the disclosed products and processes. It is understood that the various embodiments described and illustrated in this specification are non-limiting and non-exhaustive. Thus, the invention is not limited by the description of the various non-limiting and non-exhaustive embodiments disclosed in this specification. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or supported by, this specification. Further, Applicant reserves the right to amend the claims to affirmatively disclaim features or characteristics that may be present in the prior art. Therefore, any such amendments comply with the requirements of 35 U.S.C. §112, first paragraph, and 35 U.S.C. §132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “various non-limiting embodiments,” or the like, means that a particular feature or characteristic may be included in an embodiment. Thus, use of the phrase “in various non-limiting embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various embodiments may be combined, in whole or in part, with the features or characteristics of one or more other embodiments without limitation. Such modifications and variations are intended to be included within the scope of the present specification. In this manner, the various embodiments described in this specification are non-limiting and non-exhaustive.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges subsumed within the recited range. For example, a range of “1 to 10” is intended to include all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. §112, first paragraph, and 35 U.S.C. §132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

The present invention relates to a one-component composition comprising:
1) a ketimine which is the reaction product of:
   a) a dimer diamine; and
   b) a ketone; and
2) a blocked polyisocyanate.

As will be appreciated, the term “one-component composition” refers to a composition in which both the ketimine and blocked polyisocyanate are stored together in one container, which may also include other materials, such as those mentioned below.

The ketimine of component 1) is the reaction product of a) a dimer diamine and b) a ketone. As the dimer diamine, a fatty C36 dimer diamine, (12E,15E)-N-[(21E,24E)-hexatriaconta-21,24-dienyl]hexatriaconta-12,15-dien-1-amine, sold as PRIAMINE™ 1071, PRIAMINE™ 1073, PRIAMINE™ 1074, and PRIAMINE™ 1075, by Croda Coatings & Polymers is preferred.

The reaction of amines and ketones to form ketimines is well known to those skilled in the art. Ketones which contain two identical or two different linear and/or branched aliphatic hydrocarbon radicals with from 1 to 18 carbon atoms or one hydrocarbon radical in the form of a ring, or aromatic hydrocarbon radicals, especially phenyl radicals are particularly suitable for the production of ketimines useful in the practice of the present invention. Specific examples of suitable ketones include: methyl ethyl ketone (“MEK”), diethyl ketone, methyl isobutyl ketone (“MIBK”), diisobutyl ketone, cyclohexanones and acetophenones.

The blocked polyisocyanates of component 2) may be blocked with, for example, a phenol or oxime in accordance with the present invention and may include any of the known isocyanates. Preferred polyisocyanates are isocyanate prepolymers and adducts which have been blocked with a phenol.

The isocyanate groups may have aromatically, aliphatically, cycloaliphatically, or araliphatically-bound isocyanate groups. The polyisocyanates prior to the blocking reaction have an isocyanate content of about 1 to 30, preferably about 2 to 25 weight percent, based on the polyisocyanate, and contain an average of about 2 to 6, preferably about 2 to 4 isocyanate groups per molecule.

The polyisocyanates useful for preparing the polyisocyanate component of the present invention include monomeric polyisocyanates, polyisocyanate adducts or isocyanate-terminated prepolymers.

Suitable polyisocyanate adducts may be produced from monomeric polyisocyanates (preferably monomeric diisocyanates) and contain biuret, allophanate, urea, urethane, carbodiimide or uretdione groups or isocyanurate rings.

Polyisocyanates which may be used as the monomeric polyisocyanate or for preparing a polyisocyanate adduct include organic diisocyanates represented by the general formula

R(NCO)₂

in which

R represents an organic group obtainable by removal of the isocyanate groups from an organic diisocyanate having a molecular weight of from about 112 to 1,000, and preferably from about 140 to 400. Preferred diisocyanates are those represented by the general formula indicated above in which

R represents a divalent aliphatic hydrocarbon group having from 4 to 18 carbon atoms, a divalent cycloaliphatic hydrocarbon group having from 5 to 15 carbon atoms, a divalent araliphatic hydrocarbon group having from 7 to 15 carbon atoms, or a divalent aromatic hydrocarbon group having 6-15 carbon atoms.

Examples of organic diisocyanates which are particularly suitable for use herein include: 1,4-tetramethylene diisocyanate; 1,6-hexamethylene diisocyanate; 2,2,4-trimethyl-1,6-hexamethylene diisocyanate; 1,12-dodecamethylene diisocyanate; cyclohexane-1,3-, and -1,4-diisocyanate; 1-isocyanato-2-isocyanato-methyl cyclopentane; 1-isocyanato-3-isocyanatomethyl-3,5,5-trimethylcyclohexane (isophorone diisocyanate or IPDI); bis-(4-isocyanatocyclohexyl)methane; 1,3- and 1,4-bis-(isocyanatomethyl)-cyclohexane; bis-(4-isocyanato-3-methyl-cyclohexyl)-methane; α,α,α′,α′-tetramethyl-1,3- and/or 1,4-xylylene diisocyanate; 1-isocyanato-1-methyl-4(3)-isocyanatomethyl cyclohexane; 2,4- and/or 2,6-hexahydrotoluene diisocyanate; 1,3- and/or 1,4-phenylene diisocyanate; 2,4- and/or 2,6-toluene diisocyanate (“TDI”); 2,4- and/or 4,4-diphenylmethane diisocyanate and 1,5-diisocyanato naphthalene. Also suitable are polyisocyanates such as 4,4′,4″-triphenylmethane triisocyanate and polyphenyl polymethylene polyisocyanates obtained by phosgenating aniline/formaldehyde condensates. Mixtures of diisocyanates and/or polyisocyanates may, of course, also be used. Preferred diisocyanates are 1,6-hexamethylene diisocyanate; isophorone diisocyanate; bis-(4-isocyanatocyclohexyl)-methane; 2,4- and/or 2,6-toluene diisocyanate; and 2,4′- and/or 4,4′-diphenyl methane diisocya-nate.

Polyisocyanate adducts containing biuret groups may be prepared from the previously mentioned diisocyanates by processes such as those disclosed in U.S. Pat. No. 3,124,605; 3,358,010; 3,644,490; 3,862,973; 3,903,126; 3,903,127; 4,051,165; 4,147,714 or 4,220,749 by using co-reactants such as water, tertiary alcohols, primary and secondary monoamines, and primary and/or secondary diamines. The preferred diisocyanate to be used in these processes is 1,6-diisocyanato-hexane.

Polyisocyanate adducts containing allophanate groups may be prepared by from diisocyanates by any of the processes disclosed in U.S. Pat. Nos. 3,769,318 and 4,160,080; British Patent 994,890; and German Offenlegungsschrift 2,040,645.

Polyisocyanate adducts containing isocyanurate groups may be prepared by trimerizing diisocyanates in accordance with the processes disclosed in U.S. Pat. Nos. 3,487,080; 3,919,218; 4,040,992; 4,288,586; and 4,324,879; German Auslegeschrift 1,150,080; German Offenlegungsschrift 2,325,826; and British Patent 1,465,812. The preferred diisocyanates to be used for producing such adducts are 2,4-diisocyanatotoluene, 2,6-diisocyanatotoluene and mixtures of these isomers; 1,6-diisocyanatohexane; isophorone diisocyanate and mixtures of 1,6-diisocyanatohexane and isophorone diisocyanate.

Polyisocyanate adducts containing urea or urethane groups which are the reaction products of a diisocyanate and a compound having a molecular weight of less than 400 and containing 2 or more isocyanate-reactive hydrogens may be prepared by the process disclosed in U.S. Pat. No. 3,183,112. When preparing polyisocyanate adducts using a large excess of diisocyanate, the average isocyanate functionality may be determined from the functionality of the compounds containing isocyanate-reactive hydrogens. For example, theoretically when an excess of a diisocyanate is reacted with a diol, a polyisocyanate with a functionality of approximately 2 will be produced, while a triol co-reactant will result in a polyisocyanate functionality of at least 3. By using mixtures of compounds containing isocyanate-reactive hydrogens, various functionalities can be obtained. Preferably the polyisocyanates used in the present invention have a functionality of at least 1.5. In an alternate embodiment, the polyisocyanates used in the present invention have a functionality of at least 2.0. In an alternate embodiment, the polyisocyanates used in the present invention have a functionality of at least 2.5.

The preferred isocyanate-reactive hydrogen-containing compounds are disclosed in U.S. Pat. No. 3,183,112. Examples of appropriate isocyanate-reactive compounds include: ethylene glycol; 1,2- and 1,3-propylene glycol; 1,3- and 1,4-butanediol; 1,6-hexanediol; 1,8-octane-diol; neopentyl glycol; diethylene glycol; 2-methyl-1,3-propylene glycol; 2,2,-dimethyl-1,3-propylene glycol; the various isomeric bis-hydroxymethyl cyclohexanes; 2,2,4-tri-methyl-1,3-pentanediol; glycerine; trimethylol propane; ethylene diamine; diethylene triamine; triethylene tetraamine; 1,6-hexanediamine; piperazine; 2,5-dimethyl piperazine; 1-amino-3-aminomethyl-3,5,5-trimethylcyclohexane; bis(4-aminocyclohexyl)methane; bis(4-amino-3-methylcyclohexyl)methane; 1,4-cyclohexanediamine; 1,2-propanediamine; hydrazine; aminoacid hydrazides; hydrazides of semicarbazido carboxylic acids; bis-hydrazides and bis-semicarbzides; 1,3- and 1,4-butanediol; 2,2,4-trimethyl-1,3-pentanediol; trimethylol propane; and mixtures thereof. It is also possible to use any of the above-described polyisocyanate adducts for the further preparation of polyisocyanate adducts containing urethane or urea groups. Preferred diisocyanates for the preparation of polyisocyanate adducts containing urethane or urea groups are 2,4-diisocyanatotoluene, 2,6-diisocyanatotoluene, 1,6-diisocyanatohexane, isophorone diisocyanate and mixtures of these diisocyanates.

In addition to monomeric polyisocyanates or polyisocyanate adducts, the polyisocyanate component of the present invention may be prepared from isocyanate-terminated prepolymers. These prepolymers are formed by reacting an excess of polyisocyanate (preferably monomeric diisocyanate) with a high molecular weight isocyanate-reactive compound and optionally a low molecular weight isocyanate-reactive compound. Prepolymers prepared exclusively from polyisocyanates and low molecular weight isocyanate-reactive compounds are referred to as polyisocyanate adducts containing urea and/or urethane groups and have previously been discussed. A sufficient excess of the polyisocyanate should be used to ensure that the prepolymers are terminated with isocyanate groups. The high molecular weight compounds to be used with the previously described polyisocyanates for preparing the isocyanate-terminated prepolymers are selected from the known compounds containing isocyanate-reactive groups, preferably hydroxyl groups, which are at least difunctional in the sense of the isocyanate-addition reaction. These compounds generally have an average functionality of from about 2 to about 8, preferably from about 2 to about 4. The compounds containing at least two isocyanate-reactive hydrogen atoms generally have a molecular weight (as determined by end group analysis) of from about 400 to about 10,000, preferably from about 400 to about 8,000. Examples of the high molecular weight isocyanate-reactive compounds are polyester polyols, polyether polyols and amines, polyhydroxy polycarbonates, polyhydroxy polyacetals, polyhydroxy polyacrylates, polyhydroxy polyester amides and polyhydroxy polythioethers. The preferred high molecular weight isocyanate-reactive compounds are the polyhydroxyl polyethers, polyesters, polylactones, polycarbonates, polyester carbonates and especially polyacrylates.

Suitable polyester polyols include the reaction products of polyhydric alcohols (preferably dihydric alcohols to which trihydric alcohols may be added) and polybasic (preferably dibasic) carboxylic acids. In addition to polycarboxylic acids, carboxylic acid anhydrides and polycarboxylic acid esters of lower alcohols or mixtures thereof may be used to produce the polyesters. The polycarboxylic acids, anhydrides and esters may be aliphatic, cycloaliphatic, aromatic, and/or heterocyclic. These polycarboxylic acids, anhydrides or esters may be substituted, e.g., by halogen atoms, and/or unsaturated. Examples of suitable carboxylic acids, anhydrides and esters include: succinic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride, fumaric acid, dimeric and trimeric fatty acids such as oleic acid, which may be mixed with monomeric fatty acids; dimethyl terephthalates and bis-glycol terephthalate. Suitable polyhydric alcohols include: ethylene glycol; propylene glycol-(1,2)- and -(1,3); butylene glycol-(1,4) and -(1,3); hexanediol-(1,6); octanediol-(1,8); neopentylglycol; cyclohexane dimethano-(1,4)-bis-hydroxymethylcyclohexane); 2-methyl-1,3-propanediol; 2,2,4-trimethyl-1,3-pentanediol; triethylene glycol; tetraethylene glycol; polyethylene glycol; dipropylene glycol; polypropylene glycol; dibutylene glycol; polybutylene glycol; glycerine and trimethylolpropane. The polyesters may also contain a portion of carboxyl end groups. Polyesters of lactones (e.g., ε-caprolactone) or hydroxycarboxylic acids (e.g., 6-hydroxycaproic acid), may also be used.

Polycarbonates containing hydroxy groups are known. Such products may be obtained by reacting diols (e.g., propanediol (1,3), butanediol-(1,4) and/or hexanediol-(1,6), diethylene glycol, triethylene glycol or tetraethylene glycol) with phosgene, diarylcarbonates such as diphenylcarbonate or with cyclic carbonates such as ethylene or propylene carbonate. Polyester carbonates obtained by reacting the polyesters or polylactones described above with phosgene, diaryl carbonates or cyclic carbonates.

Suitable polyether polyols may be obtained in known manner by reacting starting compounds which contain reactive hydrogen atoms with alkylene oxides such as ethylene oxide; propylene oxide; butylene oxide; styrene oxide; tetrahydrofuran or epichlorohydrin or with mixtures of these alkylene oxides. It is preferred that the polyethers do not contain more than about 10% by weight of ethylene oxide units. Most preferably, polyethers obtained without the addition of ethylene oxide are used. Suitable starting compounds containing reactive hydrogen atoms include the polyhydric alcohols described above as being useful for preparing the polyester polyols and, in addition, water; methanol; ethanol; 1,2,6-hexane triol; 1,2,4-butane triol; trimethylol ethane; pentaerythritol; mannitol; sorbitol; methyl glycoside; sucrose; phenol; isononyl phenol; resorcinol; hydroquinone; 1,1,1- or 1,1,2-tris-(hydroxylphenyl)-ethane.

Polyethers which have been produced from compounds containing amine compounds may also be used, but are less preferred. Suitable compounds containing amine groups which may be used as starting materials for the production of polyethers include: ammonia; methyl amine; tetramethylene diamine; ethanolamine; diethanolamine; triethanolamine; ethylene diamine; diethylene triamine; triethylene tetraamine; 1,6-hexane diamine; piperazine; 2,5-dimethyl piperazine; 1-amino-3-aminomethyl-3,3,5-trimethyl cyclohexane; bis-(4-aminocyclo-hexyl)-methane; bis-(4-amino-3-methylcyclohexyl)-methane; 1,4-cyclohexane diamine; 1,2-propane diamine; hydrazine; aminoacid hydrazides; hydrazides of semicarbazido carboxylic acids; bis-hydrazides; bis-semicarbazides; aniline; phenylene diamine; 2,4- and 2,6-toluene diamine; polyphenylene polymethylene polyamines of the type obtained by the aniline/formaldehyde condensation reaction and mixtures thereof. Resinous materials such as phenol and cresol resins may also be used as starting materials.

Polyethers modified by vinyl polymers are also suitable for producing the isocyanate group terminated prepolymers useful in the practice of the present invention. These polyethers may be obtained by polymerizing styrene and acrylonitrile in the presence of a polyether (U.S. Pat. Nos. 3,383,351; 3,304,273; 3,523,095; 3,110,695 and German Patent 1,152,536). Amino polyethers in which at least a portion of the hydroxyl groups of a polyether are converted to amino groups.

The preferred starting compounds for the polyethers are those compounds which exclusively contain hydroxyl groups, while compounds containing tertiary amine groups are less preferred and compounds containing isocyanate-reactive-NH groups are much less preferred.

Among the polythioethers which are useful in producing isocyanate-terminated prepolymers, are the condensation products obtained from thiodiglycol on its own and/or with other glycols, dicarboxylic acids, formaldehyde, aminocarboxylic acids or amino alcohols. The products obtained are either polythio-mixed ethers, polythioether esters or polythioether ester amides.

Suitable polyacetals include the compounds prepared from aldehydes (e.g., formaldehyde) and glycols such as diethylene glycol, triethylene glycol, ethoxylated 4,4′-di-hydroxy-diphenyldimethylmethane, and hexanediol-(1,6). Polyacetals suitable for the practice of the present invention may also be prepared by the polymerization of cyclic acetals.

Polyhydroxy polyester amides and polyamines which are the predominantly linear condensates obtained from polybasic saturated and unsaturated carboxylic acids or their anhydrides and polyvalent saturated or unsaturated aminoalcohols, diamines, polyamines and mixtures thereof are also suitable for the production of isocyanate terminated prepolymers to be used in the practice of the present invention.

Monomers useful for producing hydroxy-functional polyacrylates include acrylic acid, methacrylic acid, crotonic acid, maleic anhydride, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, glycidyl acrylate, glycidyl methacrylate, 2-isocyanatoethyl acrylate and 2-isocyanatoethyl methacrylate.

In addition to high molecular weight isocyanate reactive compounds, the isocyanate-terminated prepolymers may also optionally be prepared with low molecular weight isocyanate-reactive compounds having an average molecular weight of up to 400. The low molecular weight isocyanate-reactive compounds should have an average functionality of from about 2 to about 8, preferably from about 2 to about 6 and most preferably from about 2 to about 4. These low molecular weight compounds may also contain ether, thioether, ester, urethane and/or urea bonds.

Examples of low molecular weight compounds include the polyamines and dials or triols used as chain lengthening agents or cross-linking agents in polyurethane chemistry. Examples of such compounds are those listed as suitable for preparing the polyisocyanate adducts containing urethane or urea groups and the polyester and polyether polyols. Additional examples include those listed in U.S. Pat. Nos. 4,439,593 and 4,518,522.

A solvent or solvent mixture may be used during the production of the polyisocyanate adducts or isocyanate-terminated prepolymers but a solvent is not necessary. When a solvent is employed (e.g., to promote thorough mixing of the compounds used for preparing the isocyanate-terminated prepolymer), the solvent or solvent mixture is subsequently distilled off (preferably under vacuum) to recover a ready-to-use, liquid polyisocyanate component in solvent-free form.

Suitable solvents include any of the known polyurethane solvents. Examples of such solvents are: toluene; xylene; butyl acetate; ethylacetate; ethylene glycol monoethyl ether acetate (EGA); ethylene glycol monomethyl ether acetate; ethylene glycol monobutyl ether acetate; diethylene glycol monomethyl ether acetate; diethylene glycol monobutyl ether acetate; propylene glycol monomethyl ether acetate; methyl ethyl ketone or methyl isobutyl ketone; hydrocarbon solvents such as hexane and heptane; aromatic solvents and also mixtures of the above solvents.

Useful blocking agents include agents include, e.g., oximes (preferably butanonoxime), lactams (preferably ε-caprolactam), acetoacetates (preferably ethyl acetylacetate), malonates (preferably diethyl malonate) or substituted phenols.

Prior to their use in accordance with the present invention, the isocyanate groups of the polyisocyanate component are blocked with, for example, a phenolic blocking agent or an oxime. Examples of suitable phenolic blocking agents include phenol; or alkylated phenols such as nonylphenol; the cresols; the trimethyl phenols and the tert.-butyl phenols. The reaction between the isocyanate groups and the blocking agent is conducted at a temperature of from about 50° to about 120° C., preferably from about 70° to about 100° C.

The reaction may be conducted in the presence of a solvent although the presence of a solvent is not necessary. Suitable solvents include those listed above as being useful for preparing the polyisocyanate adducts or isocyanate-terminated prepolymers.

Oximes useful as blocking agents include those disclosed and discussed in U.S. Pat. No. 6,103,849, col. 8 and 9, the disclosure of which is incorporated herein by reference. Such oximes include acetophenone oxime, acetone oxime, methyl ethyl ketoxime, and cydohexanone oxime. Other oximes which can be used as blocking agents are propyl aldehyde oxime, formaldoxime, butyl aldehyde oxime, cyclopentanone oxime, benzophenone oxime, methyl amyl ketoxime and methyl isobutyl ketone oxime.

The one component compositions of the present invention are typically cured at room temperature with sufficient humidity in the air to cure the resin. However, they may be cured from temperatures slightly below room temperature to 200° C.

The one component composition of the present invention can be cured to form sealants, coatings, adhesives and elastomers.

Other materials which may optionally be used in the composition of the present invention include fillers and additives such as plasticizers, catalysts, levelling agents, defoamers, pigments, dyes, ultraviolet stabilizers, antioxidants, stabilizers, flow control agents, blowing agents and the like which are known in the art.

Sealant compositions of the present invention in particular will often contain a significant amount of filler. For example, in some cases, a filler, such as calcium carbonate, is present in the compositions of the present invention in an amount of at least 10 percent by weight, such as at least 20 percent by weight, at least 25 percent by weight, or in some cases, at least 30 percent by weight and/or up to 70 percent by weight, such as up to 60 percent by weight, or, in some cases, up to 50 percent by weight, the weight percents being based on the total weight of the composition.

Examples of other suitable fillers for use in the inventive sealant compositions include carbon black, precipitated hydrated silicas, mineral chalk materials and precipitated chalk materials. Examples of suitable non-functional plasticizers include phthalic acid esters, adipic acid esters, alkylsuiphonic acid esters of phenol, or phosphoric acid esters. Examples of thixotropic agents include pyrogenic hydrated silicas, polyamides, products derived from hydrogenated castor oil, and also polyvinyl chloride.

The compositions of the present invention can be used for the coating, joining and sealing of materials made, for example, from metal, ceramic, glass, plastic, wood, concrete and other construction materials. In some embodiments, the compositions of the present invention may be used to seal an aperture (i.e., gap) by depositing the composition over at least a portion of the aperture. Such apertures may be present within a single substrate or between two or more different substrates.

The invention is further illustrated by but is not intended to be limited by the following examples.

### EXAMPLES

In the following examples all parts and percentages are weight percentages, unless otherwise indicated.

PRIAMINE® 1074 is a dimer diamine (available from Croda Coatings & Polymers, New Castle, Del.).

MESAMOLL® is a phthalate-free plasticizer (available from Lanxess Corporation, Pittsburgh, Pa.).

SANTICIZER® P-1000 is a phthalate-free plasticizer (available from Ferro Corporation, Independence, Ohio).

DRIKALITE® is high grade calcium carbonate (available from Imerys North America, Rosewell, Ga.).

DESMOCAP® 11 A is a blocked urethane prepolymer based on TDI having a blocked NCO % of approximately 3.0% by weight (available from Bayer MaterialScience LLC, Pittsburgh, Pa.).

DESMOCAP® 12 A is a blocked urethane prepolymer based on TDI having a blocked NCO % of approximately 2.0% by weight (available from Bayer MaterialScience LLC, Pittsburgh, Pa.).

JEFFAMINE® D-400 is a polyether diamine having a molecular weight of about 430 (available from Huntsman Chemical, Woodlands, Tex.).

JEFFAMINE® D-2000 is a polyether diamine having a molecular weight of about 2000 (available from Huntsman Chemical, Woodlands, Tex.).

ULTRA-PFLEX® is precipitated calcium carbonate (available from Specialty Minerals, Bethlehem, Pa.).

### Example 1

Methyl Isobutyl Ketone (MIBK) was charged into a 1-liter round bottom flask. PRIAMINE® 1074 was then added to the flask. The round bottom flask was equipped with a thermocouple, Dean-Stark trap, dry ice cold finger and a heating mantle. The reagents were heated to 100° C. The temperature was increased to 120° C. as water was collected in the Dean-Stark trap. When the Dean-Stark trap stopped collecting water the reaction mixture was cooled to room temperature. The mixture was tested for water content.

Test for H2O content via Karl Fisher titration—Average 0.0766% or 766 ppm.

The glassware was set up for vacuum distillation. The mixture was heated to 120° C. After 2 hours the condenser stopped yielding distillate and the product was cooled under atmospheric pressure.

### Examples 2-5

Four films were produced according to the following procedure, using the components and amounts (in parts by weight) shown in TABLE 1 below.

DRIKALITE® CaCO3 was dried in a vacuum oven over for 4 hours. Ketimine according to Example 1, DESMOCAP® 11A, and DRIKALITE® were combined in a Flack Tek plastic cup. The mixture was speed mixed for 60 seconds at 2400 rpm. A film of the mixture was drawn down on polypropylene plastic at a thickness of 100 mils. The film was immediately placed into a room with a controlled atmosphere (72° F. at 50% relative humidity).

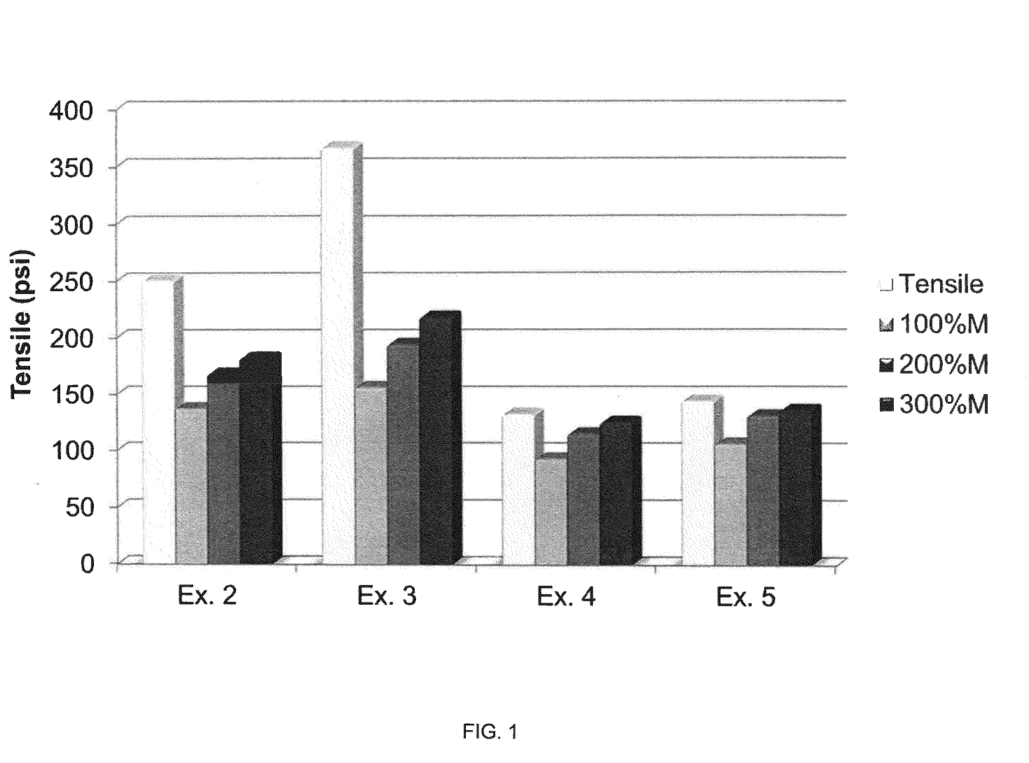

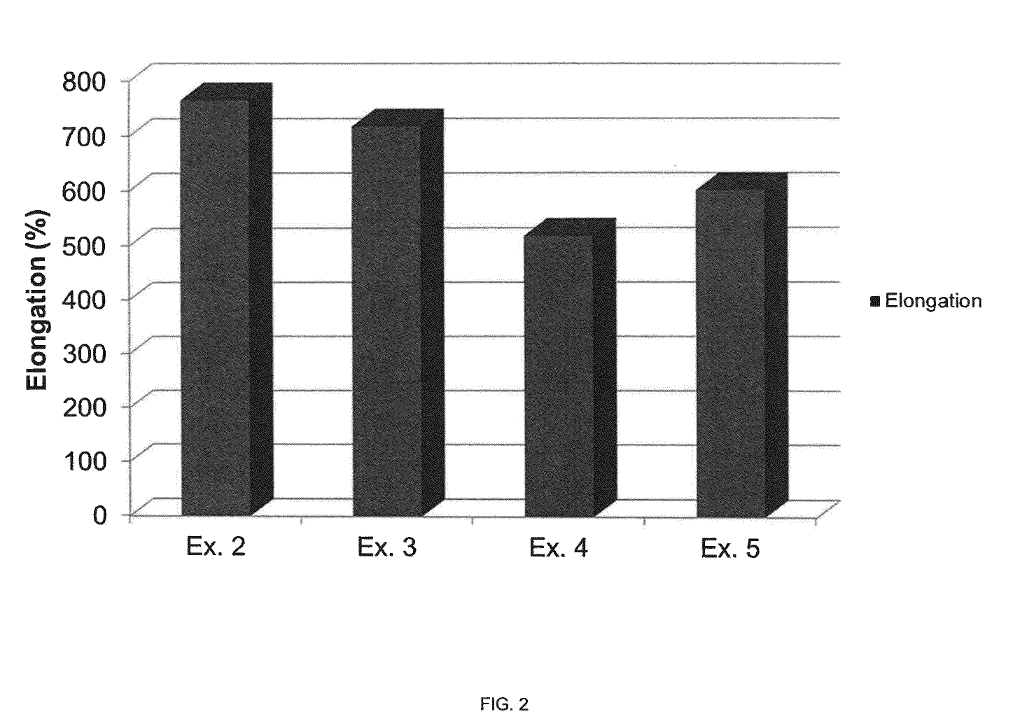

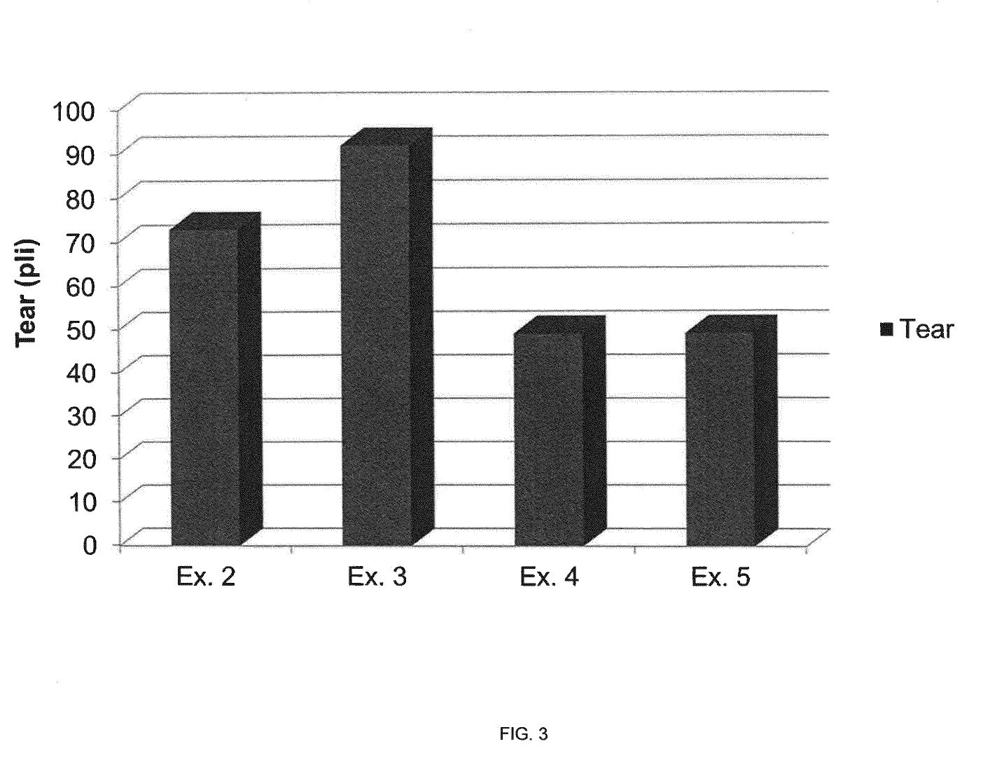

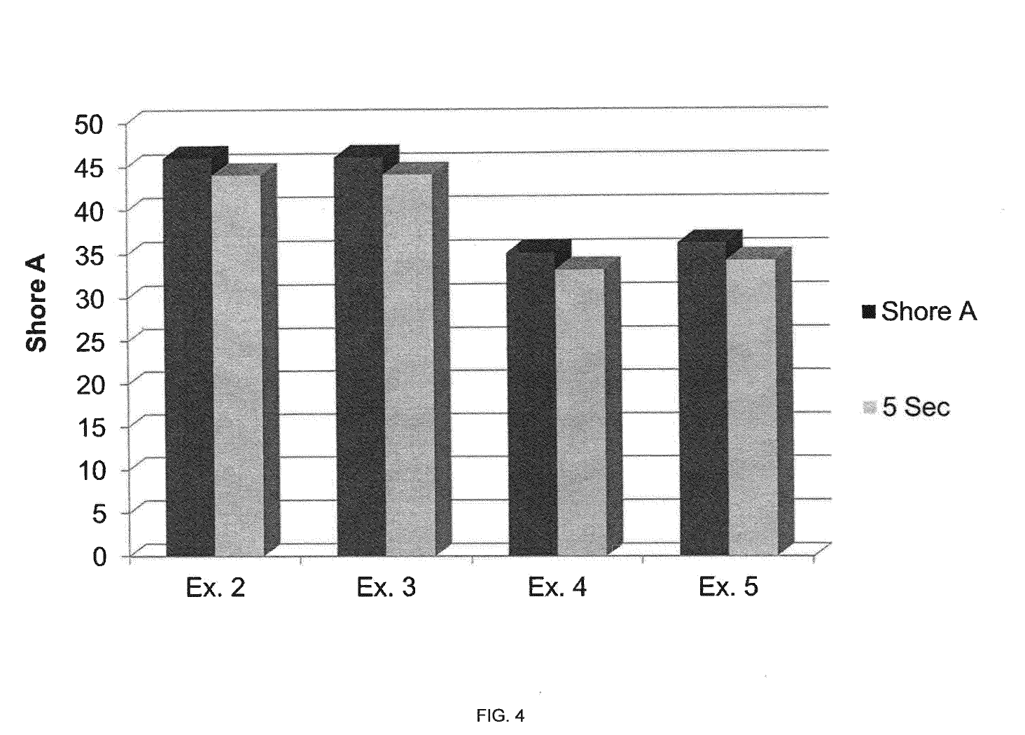

The resulting films were tested for tensile and elongation according to ASTM D-412, at a head speed of 20 in/min; tear (Die C) according to ASTM D-624 and hardness according to ASTM D2240 type A. The results are shown in FIGS. 1-4.

TABLE 1

| Example | 2 | 3 | 4 | 5 |
|---|---|---|---|---|
| Ketimine according to Example 1 | 9.98 | 9.98 | 6.65 | 4.99 |
| DESMOCAP ® 11A | 50.02 | 50.02 | 33.35 | 25.01 |
| Drikalite/atomite (75/25) | 39 | 0 | 49 | 54 |
| Santicizer ® P-1000 | 0 | 0 | 10 | 15 |
| UltraPflex ® | 0 | 39 | 0 | 0 |
| TiO2 | 1 | 1 | 1 | 1 |
| Day 1 | X | X | X | X |
| Day 2 | | X | X | X |
| Day 3 | Tack free | Slight tack | Slight tack | Slight tack |
| Day 4 | Removed film | Sl. Tack almost cured | Tackier than 3&5 | Strengthening |
| Day 7 | | Slight tack | Less tack | Slight tack |
| Day 8 | | Tack free | Very low tack | Very low tack |
| Day 10 | | Cured | Almost cured | Almost cured |
| Day 14 | | Film removed | Film removed | Film removed |

### Examples 6-11

### Preparation of Example 6

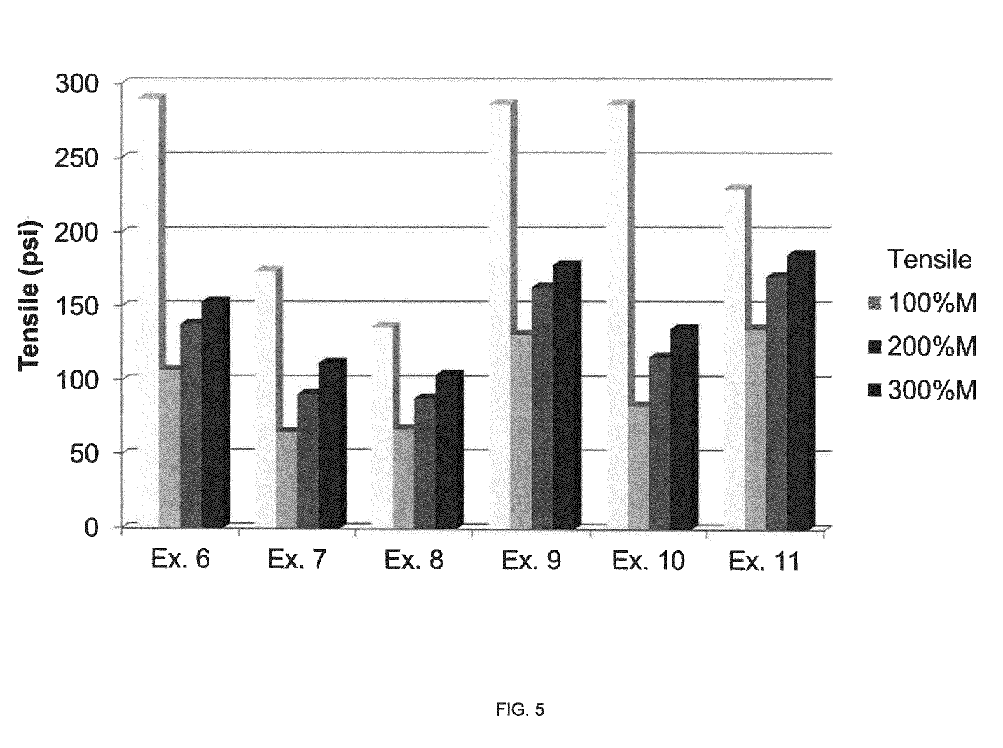

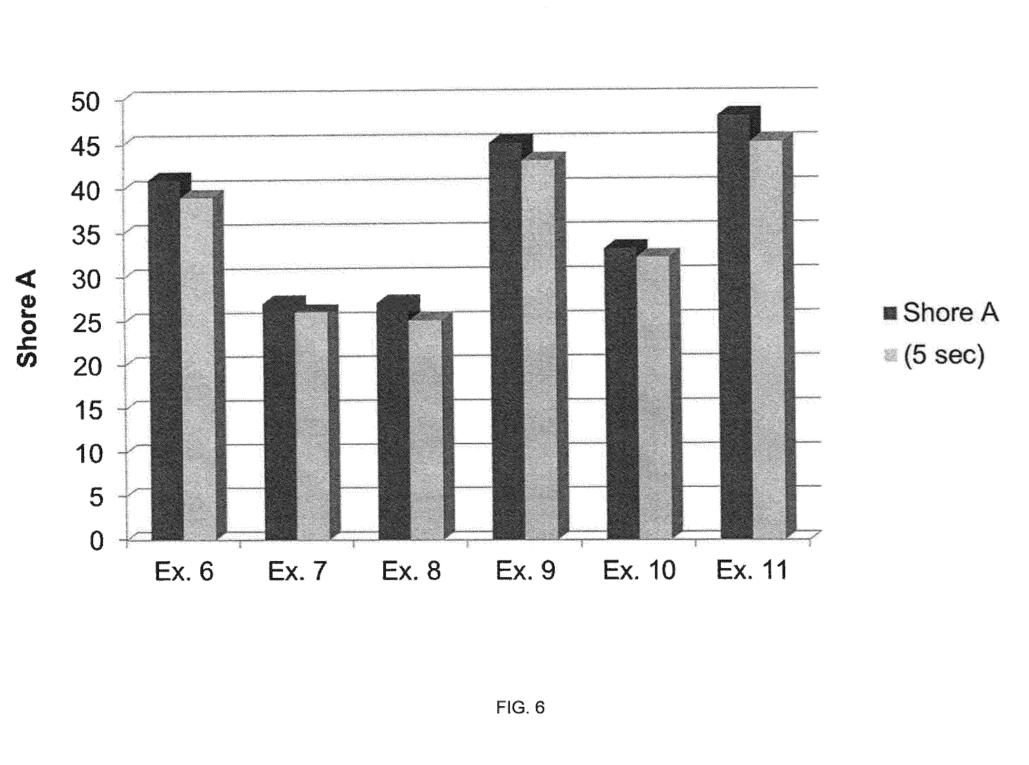

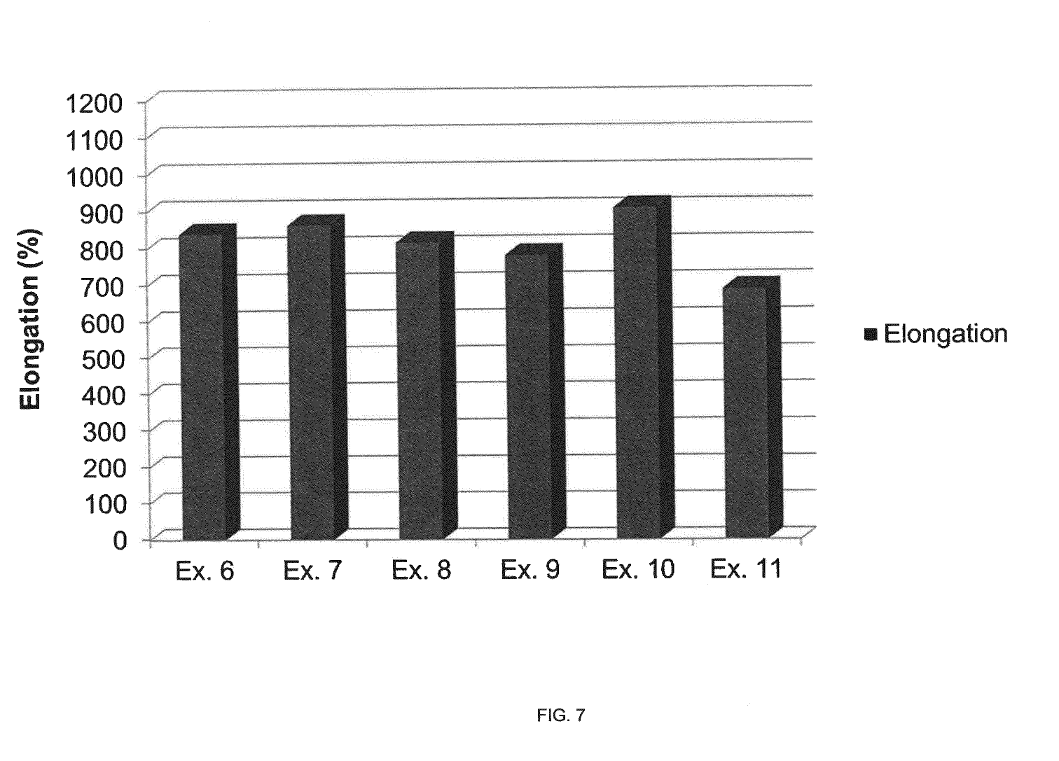

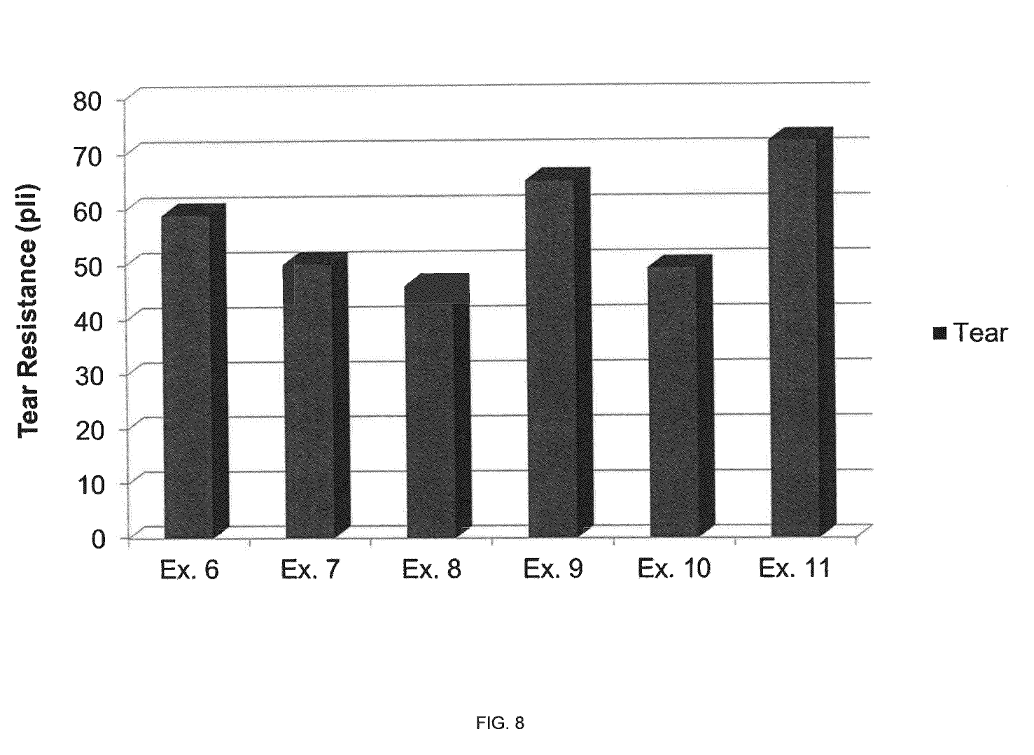

CaCO3 (DRIKALITE) and MESAMOLL were dried under vacuum for a minimum of four hours in a vacuum oven. After drying the filler, DRIKALITE (38.33 g), MESAMOL (15.0 g), DESMOCAP 11A (40.01 g), and ketimine (reaction product of PRIAMINE 1074 and MIBK) (6.64 g) were placed in a Flack Tek cup and blended in a Flack Tek spin mixer until homogeneous. A film was drawn down at a thickness of 100 mils and allowed to cure at 72° F./50% relative humidity. The film was checked for cure advancement over a 4 week period. The resulting film was submitted for testing. Results are shown in FIGS. 5-8.

### Preparation of Example 7

CaCO3 (DRIKALITE) and MESAMOLL were dried under vacuum for a minimum of four hours in a vacuum oven. After drying the filler, DRIKALITE (40.0 g), MESAMOL (10.0 g), DESMOCAP 11A (31.26 g), DESMOCAP 12A (11.14 g), and ketimine (reaction product of PRIAMINE 1074 and MIBK) (7.60 g) were placed in a Flack Tek cup and blended in a Flack Tek spin mixer until homogeneous. A film was drawn down at a thickness of 100 mils and allowed to cure at 72° F./50% relative humidity. The film was checked for cure advancement over a 4 week period. The resulting film was submitted for testing. Results are shown in FIGS. 5-8.

### Preparation of Example 8

CaCO3 (DRIKALITE) and MESAMOLL were dried under vacuum for a minimum of four hours in a vacuum oven. After drying the filler, DRIKALITE (45.46 g), MESAMOL (9.09 g), DESMOCAP 11A (28.42 g), DESMOCAP 12A (10.125 g), and ketimine (reaction product of PRIAMINE 1074 and MIBK) (6.91 g) were placed in a Flack Tek cup and blended in a Flack Tek spin mixer until homogeneous. A film was drawn down at a thickness of 100 mils and allowed to cure at 72° F./50% relative humidity. The film was checked for cure advancement over a 4 week period. The resulting film was submitted for testing. Results are shown in FIGS. 5-8.

### Preparation of Example 9

CaCO3 (DRIKALITE) and MESAMOLL were dried under vacuum for a minimum of four hours in a vacuum oven. After drying the filler, DRIKALITE (40.0 g), MESAMOL (10.0 g), DESMOCAP 11A (44.55 g), and ketimine (reaction product of PRIAMINE 1074 and MIBK) (5.45 g) were placed in a Flack Tek cup and blended in a Flack Tek spin mixer until homogeneous. A film was drawn down at a thickness of 100 mils and allowed to cure at 72° F./50% relative humidity. The film was checked for cure advancement over a 4 week period. The resulting film was submitted for testing. Results are shown in FIGS. 5-8.

### Preparation of Example 10

CaCO3 (DRIKALITE) and MESAMOLL were dried under vacuum for a minimum of four hours in a vacuum oven. After drying the filler, DRIKALITE (40.0 g), MESAMOL (20.0 g), DESMOCAP 11A (35.64 g), and ketimine (PRIAMINE 1074/MIBK) (4.36 g) were placed in a Flack Tek cup and blended in a Flack Tek spin mixer until homogeneous. A film was drawn down at a thickness of 100 mils and allowed to cure at 72° F./50% relative humidity. The film was checked for cure advancement over a 4 week period. The resulting film was submitted for testing. Results are shown in FIGS. 5-8.

### Preparation of Example 11

DRIKALITE (40.0 g), DESMOCAP 11A (50.20 g), and ketimine (reaction product of PRIAMINE 1074 and MIBK) (9.98 g) were placed in a Flack Tek cup and blended in a Flack Tek spin mixer until homogeneous. A film was drawn down at a thickness of 100 mils and allowed to cure at 72° F./50% relative humidity. The film was checked for cure advancement over a 4 week period. The resulting film was submitted for testing. Results are shown in FIGS. 5-8.

TABLE 2

| Example | 6 | 7 | 8 | 9 | 10 | 11 |
|---|---|---|---|---|---|---|
| Priamine ® 1074 | 3.82 | 4.34 | 3.97 | 3.13 | 2.51 | 5.75 |
| MIBK | 2.82 | 3.23 | 2.93 | 2.32 | 1.85 | 4.23 |
| Mesamoll ® | 15.0 | 10.0 | 9.09 | 10.0 | 20.0 | |
| Drikalite ® | | 40.01 | 45.46 | 40.0 | 40.0 | 40 |
| Desmocap ® 11A | | 31.27 | 28.42 | 44.55 | 35.64 | 50.2 |
| Desmocap ® 12A | | 11.14 | 10.13 | | | |

### Example 12

### Preparation of Ketimine A Based on JEFFAMINE®-400 and MIBK

MIBK, 166.84 g, was charged into a 1-liter round bottom flask. JEFFAMINE® D-400, 333.16 g, was then added to the flask. The round bottom flask was equipped with a thermocouple,

Dean-Stark trap, dry ice cold finger and a heating mantle. The reagents were heated to 100° C. The temperature was increased to 110° C. as water was collected in the Dean-Stark trap. When the dean stark trap stopped collecting water vacuum was applied to the flask (for 4 hours) to remove any excess MIBK or water.

### Preparation of Ketimine B Based on JEFFAMINE® D-2000 and MK

MIBK, 45.52 g, was charged into a 1-liter round bottom flask. JEFFAMINE® D-2000, 454.48 g, was then added to the flask. The round bottom flask was equipped with a thermocouple, Dean-Stark trap, dry ice cold finger and a heating mantle. The reagents were heated to 100° C. The temperature was increased to 110° C. as water was collected in the dean stark trap. When the Dean-Stark trap stopped collecting water vacuum was applied to the flask (for 4 hours) to remove any excess MIBK or water.

### Preparation of Ketimine C Based on PRIAMINE® 1074 and MIBK

MIBK, 211.86 g, was charged into a 1-liter round bottom flask. PRIAMINE® 1074, 288.14 g, was then added to the flask. The round bottom flask was equipped with a thermocouple, Dean-Stark trap, dry ice cold finger and a heating mantle. The reagents were heated to 100° C. The temperature was increased to 120° C. as water was collected in the Dean-Stark trap. When the Dean-Stark trap stopped collecting water the reaction mixture was cooled to room temperature. The mixture was tested for water content.

Test for H2O content via Karl Fisher titration—Average 0.0766% or 766 ppm The glassware was set up for vacuum distillation. The mixture was heated to 120° C. After 2 hours the condenser stopped yielding distillate and the product was cooled under atmospheric pressure.

### Preparation of Film A for Comparison Testing

DRIKALITE® CaCO3 was dried in a vacuum oven for over 4 hours. Ketimine A (7.94 g), DESMOCAP® 11A (52.06 g), and DRIKALITE® (40 g) were combined in a Flack Tek plastic cup. The mixture was speed mixed for 60 seconds at 2400 rpm. A film of the mixture was drawn down on polypropylene plastic at a thickness of 100 mils. The film was immediately placed into a room with a controlled atmosphere (72° F. at 50% relative humidity).

### Preparation of Film B for Comparison Testing

DRIKALITE® CaCO3 was dried in a vacuum oven for over 4 hours. Ketimine B (3.3 g), DESMOCAP® 11A (56.70 g), and DRIKALITE® (40 g) were combined in a Flack Tek plastic cup. The mixture was speed mixed for 60 seconds at 2400 rpm. A film of the mixture was drawn down on polypropylene plastic at a thickness of 100 mils. The film was immediately placed into a room with a controlled atmosphere (72° F. at 50% relative humidity).

### Preparation of Inventive Film C

DRIKALITE® CaCO3 was dried in a vacuum oven for over 4 hours. Ketimine C (9.98 g), DESMOCAP® 11A (50.02 g), and DRIKALITE® (40 g) were combined in a Flack Tek plastic cup. The mixture was mixed for 60 seconds at 2400 rpm. A film of the mixture was drawn down on polypropylene plastic at a thickness of 100 mils. The film was immediately placed into a room with a controlled atmosphere (72° F. at 50% relative humidity).

The results for Example 12 are shown in Table 3. As one can see, the inventive film C was cured and could be removed after 4 days, and only the inventive film C cured within 21 days.

TABLE 3

| | (A) | (B) | (C) |
|---|---|---|---|
| Ketimine | 7.94 | 3.3 | 9.98 |
| DESMOCAP ® 11A | 52.06 | 56.7 | 50.02 |
| DRIKALITE ® | 40 | 40 | 40 |
| TOTAL | 100 | 100 | 100 |

| DAY | 1 | 2 | 3 | 4 | 5 | 6 | 7 | 8 | 9 | 10 | 11 | 12 | 13 | 14 | 15 | 16 | 17 | 18 | 19 | 20 | 21 |
|---|---|---|---|---|---|---|---|---|---|---|---|---|---|---|---|---|---|---|---|---|---|
| (A) | X | X | X | X | X | X | X | X | X | X | X | X | X | X | X | X | X | X | X | X | X |
| (B) | X | X | X | X | X | X | X | X | X | X | X | X | X | X | X | X | X | X | X | X | X |
| (C) | X | tacky | skin on | tack free, | | | | | | | | | | | | | | | | | |
| | | | film, | ready for | | | | | | | | | | | | | | | | | |
| | | | slight | removal | | | | | | | | | | | | | | | | | |
| | | | tack | | | | | | | | | | | | | | | | | | |

“X” indicates the composition was uncured

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A one-component composition comprising:
1) a ketimine which is the reaction product of:
a) a dimer diamine; and
b) a ketone; and
2) a blocked isocyanate.

2. The one-component composition of claim 1, wherein:
the ketimine comprises the reaction product of
a) (12E,15E)-N-[(21E,24E)-hexatriaconta-21,24-dienyl]hexatriaconta-12,15-dien-1-amine; and
b) a ketone selected from the group consisting of methyl isobutyl ketone, acetone, methyl ethyl ketone, diethyl ketone, diisobutyl ketone, cyclohexanones and acetophenones.

3. The one-component composition of claim 2, wherein the ketone comprises methyl isobutyl ketone.

4. The one-component composition of claim 1, wherein the blocked isocyanate comprises a phenolic blocking agent or an oxime.

5. The one-component composition of claim 1, wherein the blocked isocyanate comprises a urethane prepolymer based on toluene diisocyanate having blocked isocyanate functionality.

6. The one component composition of claim 1, wherein the composition is a sealant composition.

7. The one component composition of claim 1, further comprising plasticizers and fillers.

8. The one component composition of claim 1, wherein the blocked isocyanate has a functionality of greater than 1.5.

9. A one-component composition comprising:
1) a ketimine which is the reaction product of:
a) 12E,15E)-N-[(21E,24E)-hexatriaconta-21,24-dienyl]hexatriaconta-12,15-dien-1-amine; and
b) a ketone selected from the group consisting of methyl isobutyl ketone, acetone, methyl ethyl ketone, diethyl ketone, diisobutyl ketone, cyclohexanones and acetophenones a dimer diamine; and
2) a blocked isocyanate comprising a phenolic blocking agent or an oxime

10. The one-component composition of claim 9, wherein the blocked isocyanate comprises a urethane prepolymer based on toluene diisocyanate having blocked isocyanate functionality.

11. The one component composition of claim 9, wherein the composition is a sealant composition.

12. The one component composition of claim 9, further comprising plasticizers and fillers.

13. The one component composition of claim 9, wherein the blocked isocyanate has a functionality of greater than 1.5.
